(19) United States
(12) Patent Application Publication
(10) Pub. No.: US 2012/0244274 A1
(43) Pub. Date: Sep. 27, 2012

(54) DISPENSING METHOD AND APPARATUS

(75) Inventor: Yasufumi YAMABE, Yokohama (JP)

(73) Assignee: FUJITSU SEMICONDUCTOR LIMITED, Yokohama-shi (JP)

(21) Appl. No.: 13/368,943

(22) Filed: Feb. 8, 2012

(30) Foreign Application Priority Data
Mar. 25, 2011 (JP) 2011-068719

(51) Int. Cl. B05D 5/12; B05C 5/00

(52) U.S. Cl. 427/58; 118/300

(57) ABSTRACT

A dispensing method includes feeding a liquid material to one or more ejection parts arranged in a chamber; placing one or more objects on a stage; placing the chamber on the stage and forming a first hermetic space between the chamber and the stage; placing a lid member on the chamber and forming a second hermetic space between the liquid material and the lid member; causing the liquid material to be ejected from the one or more ejection parts onto the one or more objects by reducing a pressure of the first hermetic space; and returning the first hermetic space to atmospheric pressure.

### CROSS-REFERENCE TO RELATED APPLICATION

This application is based upon and claims the benefit of priority of the prior Japanese Patent Application No. 2011-068719, filed on Mar. 25, 2011, the entire contents of which are incorporated herein by reference.

### FIELD

A certain aspect of the embodiments discussed herein is related to a liquid material dispensing method and apparatus.

### BACKGROUND

In manufacturing assemblies such as semiconductor packages, a process is often performed for applying or filling a liquid material such as an adhesive agent or underfill. Such a liquid material is typically dispensed in the atmosphere, and there is the problem of decreased reliability due to voids in the material.

FIGS. 1A through 1E are schematic diagrams illustrating generation of a void in atmospheric pressure underfill filling for a flip-chip package according to side filling. A semiconductor chip 2 having arrays of multiple projecting electrodes is provided on a wiring board 1 by flip-chip bonding, and underfill 5 is dispensed from a side of the semiconductor chip 2 so that the air gap between the wiring board 1 and the semiconductor chip 2 is filled with the underfill 5. However, as illustrated in time order in FIG. 1A through FIG. 1E, a void 9 may be formed in the liquid underfill 5 by inclusion of air. As illustrated in FIG. 1E, the void 9 remains in hardened underfill 5′, and may cause, for example, a short circuit between electrodes and/or the reduction of mechanical strength between connected electrodes to reduce the reliability of the semiconductor package.

In order to address this problem or to increase the filling speed, it has been proposed to perform underfill filling in a reduced-pressure atmosphere. For example, the technique is known of forming a hermetic space on a wiring board to enclose an air gap into which underfill is to be injected and providing the wiring board with a through hole into which the needle of the dispenser is to be inserted, and injecting the underfill while reducing the pressure of the hermetic space. Further, the technique is also known of forming a hermetic space on a wiring board in the same manner and placing the entire dispenser including a syringe in the hermetic space, and performing side filling of the underfill while reducing the pressure of the hermetic space.

For related art, reference may be made to, for example, Japanese Laid-open Patent Publication No. 10-261661, Japanese Laid-open Patent Publication No. 2001-217267, and Japanese Patent No. 4311549.

### SUMMARY

According to an aspect of the invention, a dispensing method includes feeding a liquid material to one or more ejection parts arranged in a chamber; placing one or more objects on a stage; placing the chamber on the stage and forming a first hermetic space between the chamber and the stage; placing a lid member on the chamber and forming a second hermetic space between the liquid material and the lid member; causing the liquid material to be ejected from the one or more ejection parts onto the one or more objects by reducing a pressure of the first hermetic space; and returning the first hermetic space to atmospheric pressure.

According to an aspect of the invention, a dispensing method includes applying a liquid material to a plurality of sets of objects, each of the plural sets of objects including one or more of the objects, the applying with respect to each of the plural sets of objects including feeding the liquid material to one or more ejection parts of a chamber; placing the set of objects on a stage; placing the chamber on the stage and forming a first hermetic space between the chamber and the stage;

placing a lid on the chamber and forming a second hermetic space between the liquid material and the lid; causing the liquid material to be ejected from the one or more ejection parts onto the set of objects by reducing a pressure of the first hermetic space; and returning the first hermetic space to atmospheric pressure and removing the lid, the chamber, and the set of objects from the stage, wherein plural chambers including said chamber are cyclically used one by one in repeating said applying the liquid material to the plural sets of objects.

According to an aspect of the invention, a dispensing apparatus includes a stage configured to have one or more objects placed thereon; a chamber configured to be placed on the stage, the chamber including one or more ejection parts; a dispenser configured to feed a liquid material to the one or more ejection parts; a lid configured to be placed on the chamber; and a pressure control mechanism, wherein a first hermetic space is formed between the stage and the chamber and a second hermetic space is formed between the liquid material and the lid in response to the chamber fed with the liquid material being placed on the stage and the lid being placed on the chamber, and the pressure control mechanism is configured to reduce a pressure of the first hermetic space so that the liquid material is ejected from the one or more ejection parts onto the one or more objects inside the first hermetic space and thereafter return the first hermetic space to atmospheric pressure by venting the first hermetic space to an atmosphere.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWING

FIGS. 1A through 1E are schematic diagrams illustrating underfill filling at atmospheric pressure;

FIGS. 2A through 2E are cross-sectional views illustrating a method of dispensing a liquid material according to a first embodiment;

FIGS. 3A through 3E are cross-sectional views illustrating the stage of the process of FIG. 2E in more detail according to the first embodiment;

FIGS. 4A through 4F are schematic diagrams illustrating underfill filling in a reduced-pressure atmosphere according to the first embodiment;

FIGS. 5A through 5E are cross-sectional views illustrating a method of dispensing a liquid material according to a second embodiment;

FIGS. 6A through 6F are perspective views illustrating the dispensing method of FIGS. 5A through 5E in more detail;

FIG. 7 is a diagram illustrating parts of a semiconductor package recognized by a recognition mechanism according to the second embodiment;

FIG. 8 is a flowchart illustrating the dispensing method using two chambers as illustrated in FIGS. 6A through 6F;

FIG. 9 is a flowchart illustrating the dispensing method using a single chamber as illustrated in FIGS. 2A through 2E;

FIG. 10 is a front view of a liquid material dispensing apparatus according to the second embodiment;

FIG. 11 is a plan view of the dispensing apparatus, illustrating its portion near a stage part according to the second embodiment;

FIG. 12 is a front view of the dispensing apparatus, illustrating the stage part and its vicinity along with the functional blocks of peripheral elements of the stage part according to the second embodiment; and

FIGS. 13A and 13B illustrate a main stage having a mechanism configured to control the relative positions of an object of processing and the nozzle part of a capillary according to a third embodiment.

### DESCRIPTION OF EMBODIMENTS

In the case of applying or injecting (filling) a liquid material such as underfill in a reduced-pressure atmosphere, it is possible to control generation of a void that causes a decrease in reliability. For example, even if a void is generated because of inclusion of air at the time of filling underfill as described above, the void may be reduced or eliminated at subsequent venting to the atmosphere.

However, according to the known techniques, underfill is directly supplied into a pressure-reduced atmosphere using a dispenser. Therefore, it is desired that a control mechanism for ejecting underfill in a pressure-reduced atmosphere be installed or modified.

According to an aspect of the invention, a technique is provided that makes it possible to control the generation of a void in a liquid material in dispensing the liquid material on an object (target) of processing in a reduced-pressure atmosphere without exposing the dispenser to the reduced-pressure atmosphere, that is, without modifying or changing a control mechanism that controls the dispenser.

Preferred embodiments of the present invention will be explained with reference to accompanying drawings. In the drawings, various elements are not necessarily drawn with the same scale. Further, throughout the drawings, the same elements or corresponding elements are referred to by the same or similar reference numerals.

### [a] First Embodiment

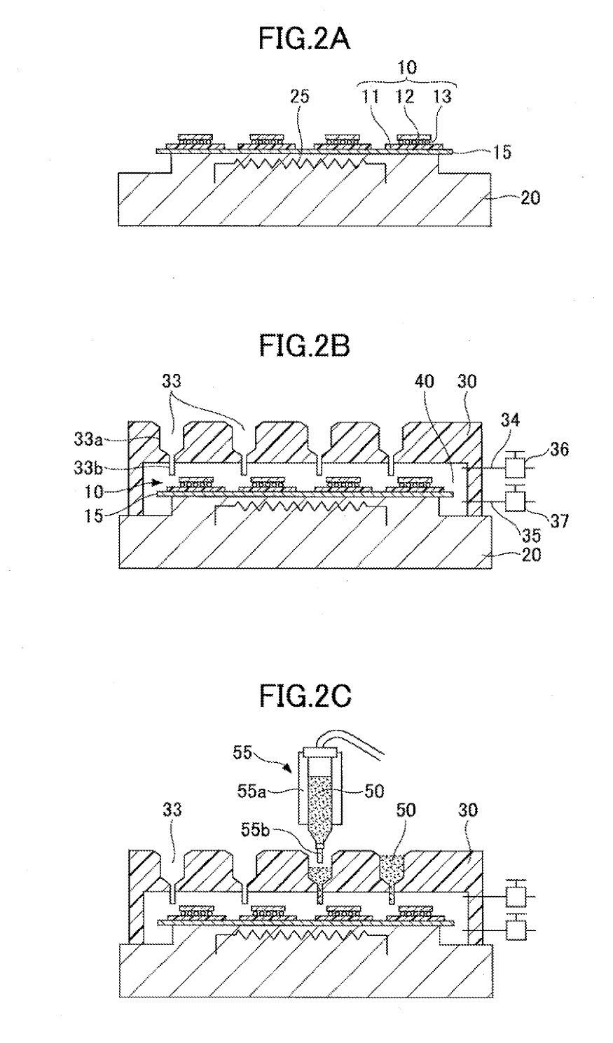

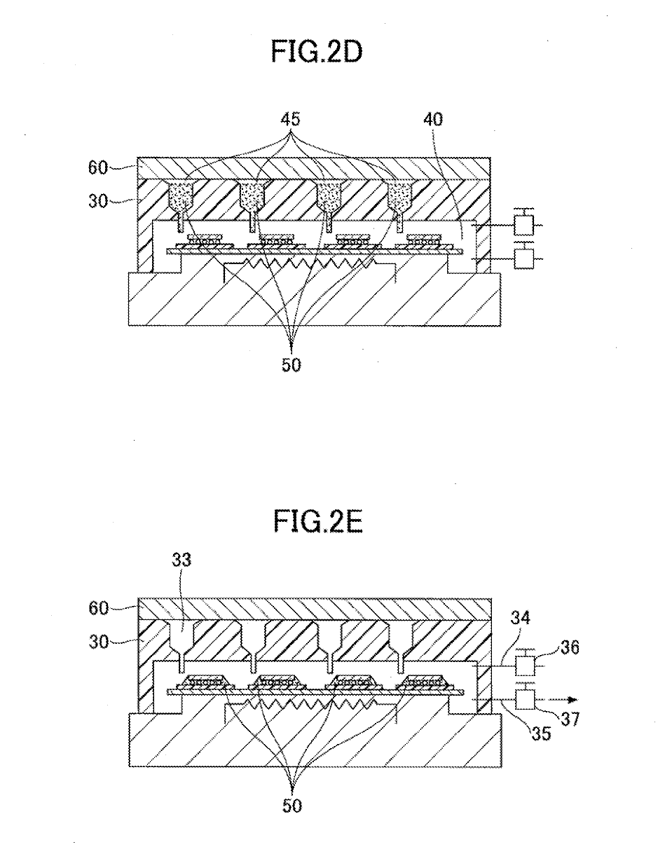

A description is given, with reference to the schematic cross-sectional views of FIGS. 2A through 2E, of a method of dispensing a liquid material according to a first embodiment. Here, a description is given, taking underfill filling according to side filling as an example. The dispensing method according to this embodiment, however, may also be applied to other liquid material applications where it is desired to control generation of voids, such as so-called underfill-first application where underfill is applied on a wiring board before the mounting of semiconductor chips and the like and application of an adhesive agent on an object of processing.

As illustrated in FIG. 2A, a semiconductor package 10 as an object (target) of processing is provided on a stage 20. A single semiconductor package 10 may be placed directly on the stage 20. Preferably, however, in view of process efficiency, multiple semiconductor packages 10 are placed over the stage 20 using a carrier 15 configured to carry the multiple semiconductor packages 10 arranged at predetermined positions.

Each of the semiconductor packages 10 includes a wiring board 11 and a semiconductor chip 12 provided on and connected to the wiring board 11 by flip-chip bonding. The semiconductor chip 12 has projecting electrodes 13 (such as bump electrodes) arranged in arrays, and is mechanically and electrically connected to the wiring board 11 with the projecting electrodes 13 serving as connecting electrodes. The projecting electrodes 13 cause an air gap to be formed between the wiring board 11 and the semiconductor chip 12. In place of the semiconductor chip 12, each of the semiconductor packages 10 may have a semiconductor package of a flipped and connected type, such as a BGA (ball grid array) type semiconductor package, mounted on the wiring board 11. The stage 20 typically includes a heater 25. The temperature of heating with the heater 25 may be determined in accordance with the type of underfill to be used so that the underfill may have such fluidity as to be able to fill in the air gap through a capillary flow. The temperature of heating is typically in the range of 100° C. from room temperature.

Next, as illustrated in FIG. 2B, a chamber 30 is placed on the stage 20. The chamber 30 is so placed as to adhere closely to the stage 20 so that a hermetic (airtight) space 40 may be formed between the chamber 30 and the stage 20. The chamber 30 has one or more ejection parts 33 (hereinafter referred to as “capillaries”) provided through the container (body) of the chamber 30.

Each of the capillaries 33 includes a syringe part 33a and a nozzle part 33b. The syringe part 33a is configured to store a liquid material, which is ejected through the nozzle part 33b. The opening of the nozzle part 33b is smaller in diameter than the syringe part 33a. Typically, the opening of the nozzle part 33b may be in the range of 0.2 mm to 1.0 mm in diameter. The nozzle part 33b communicates with the hermetic space 40 in the chamber 30. The nozzle part 33b may be formed to project into the hermetic space 40 from the inner wall surface of the chamber 30 as required as illustrated in FIG. 2B.

Each of the semiconductor packages 10 is placed so that the nozzle part 33b of the corresponding capillary 33 is at a predetermined position above the semiconductor package 10.

In this example of side filling, preferably, the end of the nozzle part 33b of each capillary 33 is positioned vertically between the surface of the wiring board 11 (on which surface the semiconductor chip 12 is mounted) and the upper surface of the semiconductor chip 12, and is positioned close to but out of contact with the semiconductor chip 12 in a region where the end of the nozzle part 33b is prevented from being buried in the underfill when the underfill is ejected.

The chamber 30 further includes an inlet port 34 and an outlet port 35, which are used at the time of switching (the condition of) the hermetic space 40 between an atmospheric condition and a reduced-pressure condition. The inlet port 34 may be connected to the outside air via an opening and closing part 36 such as a valve attached to the inlet port 34. The outlet port 35 may be connected to a pressure reducing part such as a vacuum pump via an opening and closing part 37 such as a valve attached to the outlet port 35.

The capillaries 33 are not limited to the shape illustrated in FIGS. 2B through 2E, and may have any shape as long as the shape prevents the liquid material stored in the capillaries 33 from dripping out when the pressure inside the chamber 30 is not reduced (FIGS. 2C and 2D) and allows the liquid material to be pushed out when the pressure inside the chamber 30 is reduced (FIG. 2E).

Next, as illustrated in FIG. 2C, a predetermined amount of a liquid material 50 (underfill in this case) is fed into each of the capillaries 33 using a dispenser 55. The liquid material 50 is hereinafter referred to “underfill 50.” The underfill 50 may be, for example, epoxy or cyanate ester resin.

Typically, the dispenser 55 includes a syringe 55a and a needle 55b. The dispenser 55 is configured to eject the underfill 50 contained in the syringe 55a from the needle 55b in response to application of a pressure. Here, the underfill 50 is fed to the chamber 30 placed on the stage 20. However, the underfill 50 may be fed to the chamber 30 before the placement of the chamber 30 on the stage 20.

Next, as illustrated in FIG. 2D, a lid member (which may also be simply referred to as “lid”) 60 is placed on the chamber 30 so that the lid member 60 adheres closely to the chamber 30. As a result, a hermetic (airtight) space 45 is formed between the underfill 50 and the lid member 60 in the top portion of the syringe part 33a of each of the capillaries 33.

Then, as illustrated in FIG. 2E, the pressure inside the chamber 30 is reduced via the outlet port 35 and the opening and closing part 37 attached to the outlet port 35. As a result, the underfill 50 inside the capillaries 33 is ejected onto the corresponding semiconductor packages 10, so that the air gap between the semiconductor chip 12 and the wiring board 11 of each of the semiconductor packages 10 is filled with the underfill 50. By causing the entire amount of the underfill 50 fed into the capillaries 33 in the process of FIG. 2C to be ejected, it is possible to feed a desired amount of the underfill 50 onto the semiconductor packages 10 with the accuracy of the amount of ejection of the dispenser 55.

After completion of the feeding (filling) of the underfill 50 under reduced pressure, the opening and closing part 37 attached to the outlet port 35 is again closed, and the chamber 30 is vented to the atmosphere via the inlet port 34 and the opening and closing part 36 attached to the inlet port 34. Thereafter, the lid member 60 and the chamber 30 are removed from the stage 20, and the semiconductor packages 10 and the carrier 15 are taken out. By hardening the underfill 50, the “underfilling” of the semiconductor package 10 is completed.

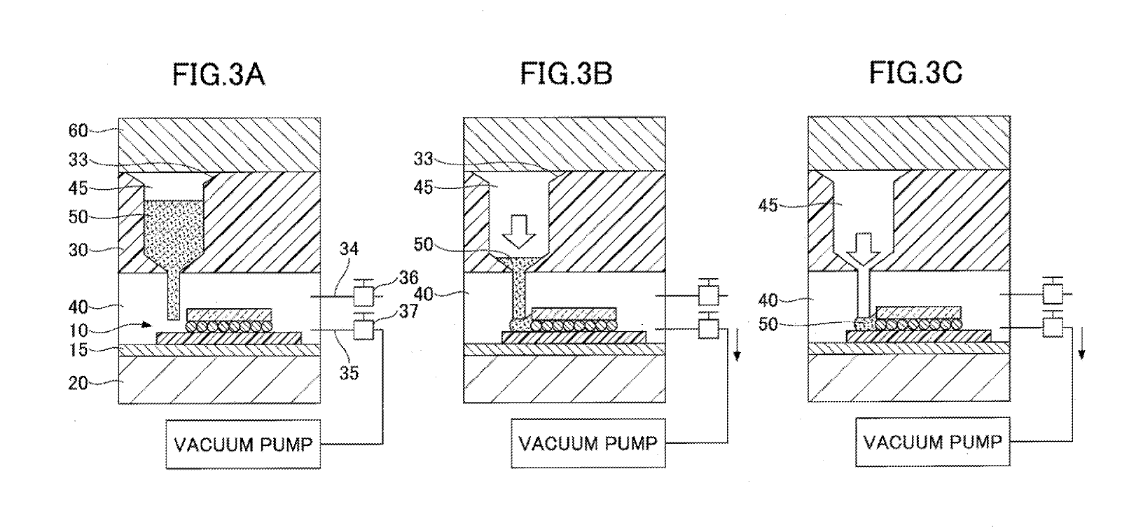

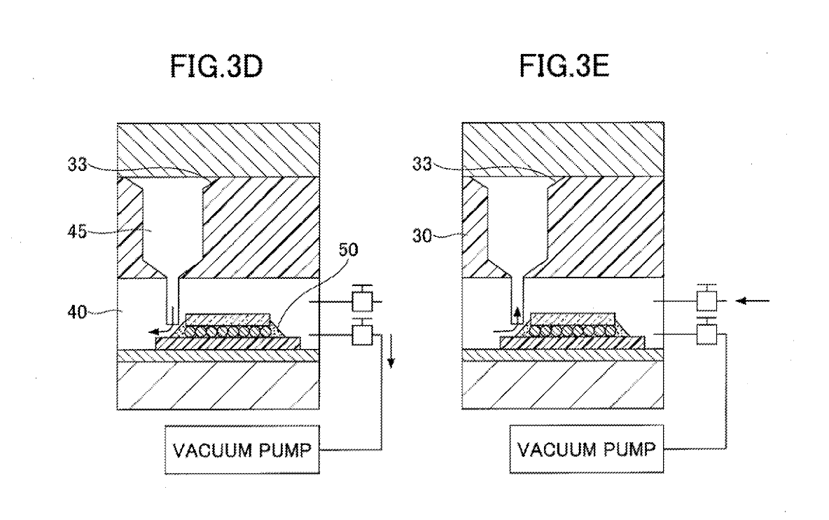

A description is given in more detail, with reference to FIGS. 3A through 3E, of the stage of the process of FIG. 2E. In FIGS. 3A through 3E, one of the semiconductor packages 10 and a corresponding one of the capillaries 33 above the one of the semiconductor packages 10 in FIG. 2E are illustrated in a larger scale.

Referring to FIG. 3A, before the start of the pressure reduction of the chamber 30, the hermetic space 40 inside the chamber 30 and the hermetic space 45 between the underfill 50 and the lid member 60 inside the capillary 33 are at atmospheric pressure, so that there is no ejection of underfill 50 from the capillary 33. When the reduction of the pressure inside the chamber 30 is started, a difference in pressure is generated between the hermetic space 40 inside the chamber 30 and the hermetic space 45 in the top portion of the capillary 33, so that the underfill 50 is pushed out of the capillary 33 (FIG. 3B).

At this point, the air inside the hermetic space 45 at the top portion of the capillary 33 expands for the amount of the underfill 50 ejected, so that the reduction of the pressure inside the hermetic space 45 progresses. As illustrated in FIG. 3C, the pushed-out underfill 50 fills in the space (air gap) between the wiring board 11 and the semiconductor chip 12 through capillary action in an atmosphere where the pressure is gradually reduced.

As illustrated in FIG. 3D, when the underfill 50 inside the capillary 33 is completely ejected, the space 40 inside the chamber 30 and the space 45 inside the capillary 33 communicate with each other to be subjected to pressure reduction together. Since the hermetic sealing at the top of each capillary 33 is maintained by the lid member 60, the interference between the capillaries 33 due to a difference in ejection time or atmosphere leakage are prevented. As illustrated in FIG. 3E, when the chamber 30 is vented to the atmosphere after completion of the filling in the reduced-pressure atmosphere, air flows into the chamber 30 and the capillary 33, so that the spaces 40 and 45 inside the chamber 30 and the capillary 33, respectively, are returned to an atmospheric pressure condition.

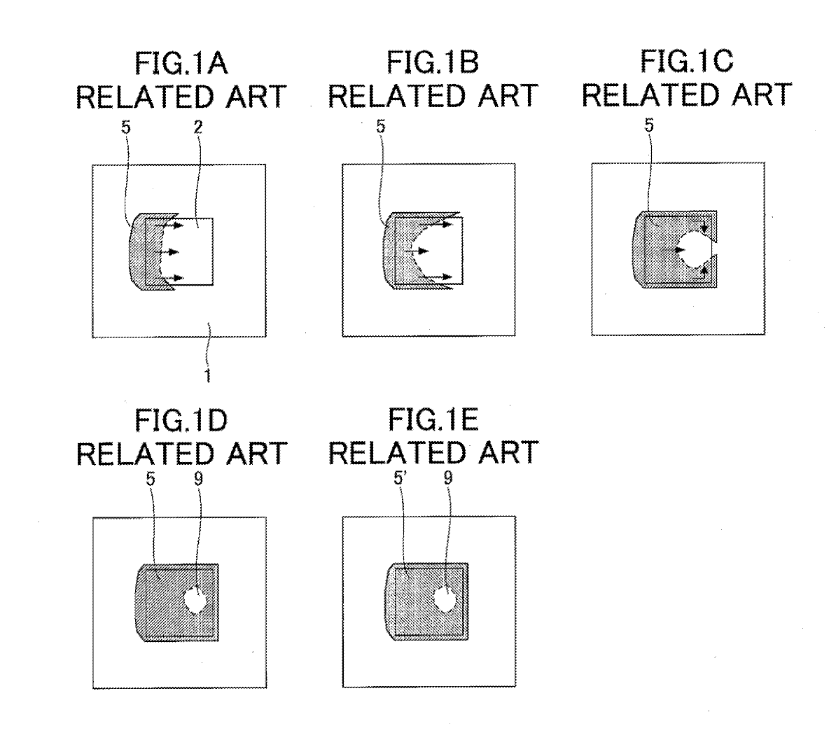

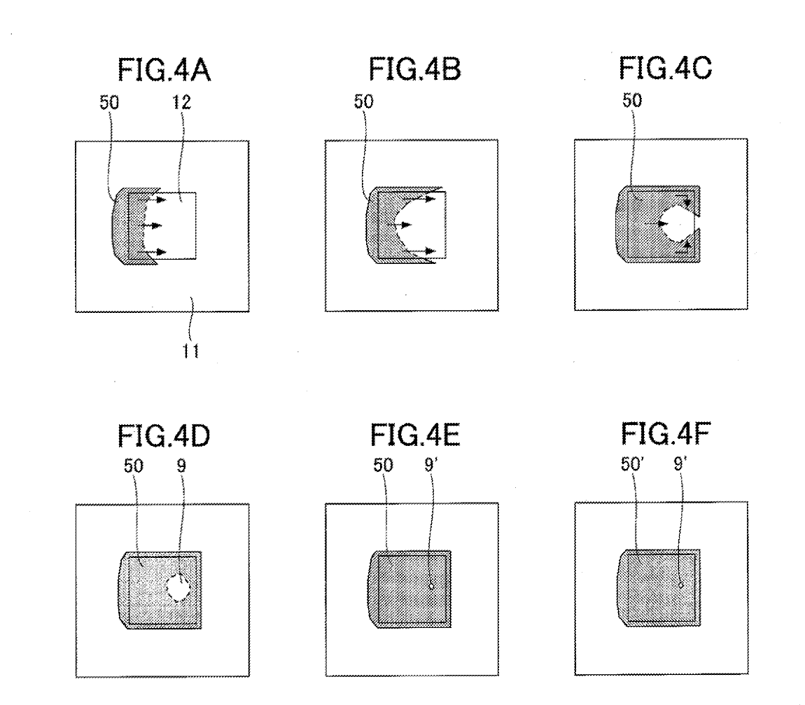

FIGS. 4A through 4F are schematic diagrams, similar to those of FIGS. 1A through 1E regarding atmospheric pressure filling, illustrating the filling of the underfill 50 in the reduced-pressure atmosphere illustrated in FIG. 2E and FIGS. 3A through 3E. FIGS. 4A through 4D are the same as FIGS. 1A through 1D, illustrating that the void 9 may be formed in the underfill 50 in a liquid state even under reduced pressure because of inclusion of air. However, as illustrated in FIG. 4E, subsequent venting to the atmosphere makes it possible to reduce or substantially eliminate the void 9. For example, if the pressure inside the chamber 30 at the time of generation of the void 9 is approximately 1 kPa, the void 9 is reduced by approximately 99% in volume to a void 9′ after venting to the atmosphere. Then, in hardened underfill 50′ as well, it is possible to control generation of a void that reduces reliability as illustrated in FIG. 4F.

The ultimate pressure at the time of reducing the pressure of the chamber 30 may be set to a suitable pressure below atmospheric pressure in accordance with the kind and the amount of a liquid material to be applied. In order to cause a small amount of the liquid material (underfill) 50 to be ejected from the capillaries 33, it is sufficient to reduce the pressure inside the chamber 30 to a pressure slightly below (lower than) atmospheric pressure. However, in the case of applying a liquid material in which a void is likely to be generated, it is preferable to reduce the pressure inside the chamber 30 to a pressure sufficiently lower than atmospheric pressure, such as approximately 10 kPa or lower, in order to sufficiently reduce the void. Further, excessively reducing the pressure inside the chamber 30 may cause degassing depending on the liquid material 50 to be used. Therefore, the ultimate pressure is preferably, for example, approximately 1 kPa or higher.

By thus reducing the pressure inside the chamber 30 to approximately 1 kPa to approximately 10 kPa, that is, to approximately 1/100 to approximately 1/10 of atmospheric pressure, it is possible to cause ejection of the liquid material 50 from the capillaries 33 and sufficiently reduce the void 9 generated.

According to the dispensing method of this embodiment, the dispenser 55, which is used to feed a predetermined amount of liquid material into the individual capillaries 33 provided in the chamber 30 under atmospheric pressure, is not exposed to a reduced-pressure atmosphere. Therefore, there is no dependence on the amount of reduction of the pressure inside the chamber 30, and there is no need to change or modify the pressure application/reduction conditions of the dispenser 55. Further, there is no need to place the dispenser 55 inside the chamber 30 subjected to pressure reduction, so that it is possible to reduce the volume of the chamber 30 to be subjected to pressure reduction. Further, providing the chamber 30 with the multiple capillaries 33 makes it possible to apply the liquid material 50 to the multiple semiconductor packages 10 simultaneously. This makes it possible to reduce time for a pressure reduction process for a desired number of semiconductor packages 10 and accordingly to improve their manufacturing throughput.

### [b] Second Embodiment

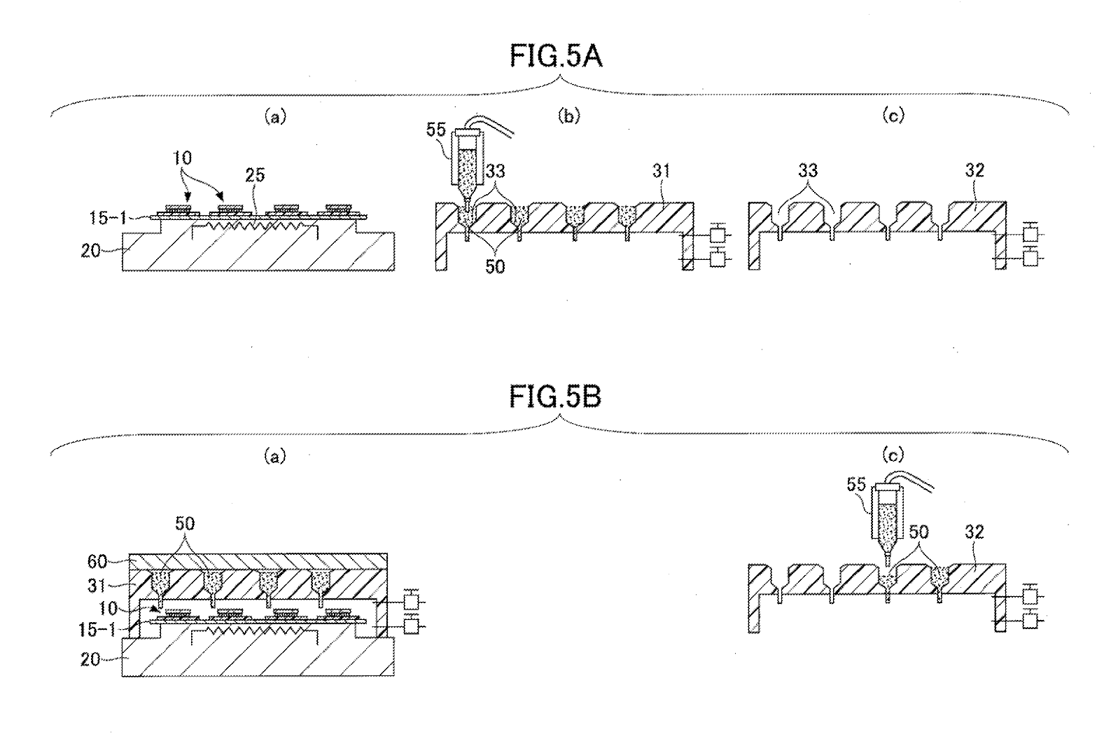

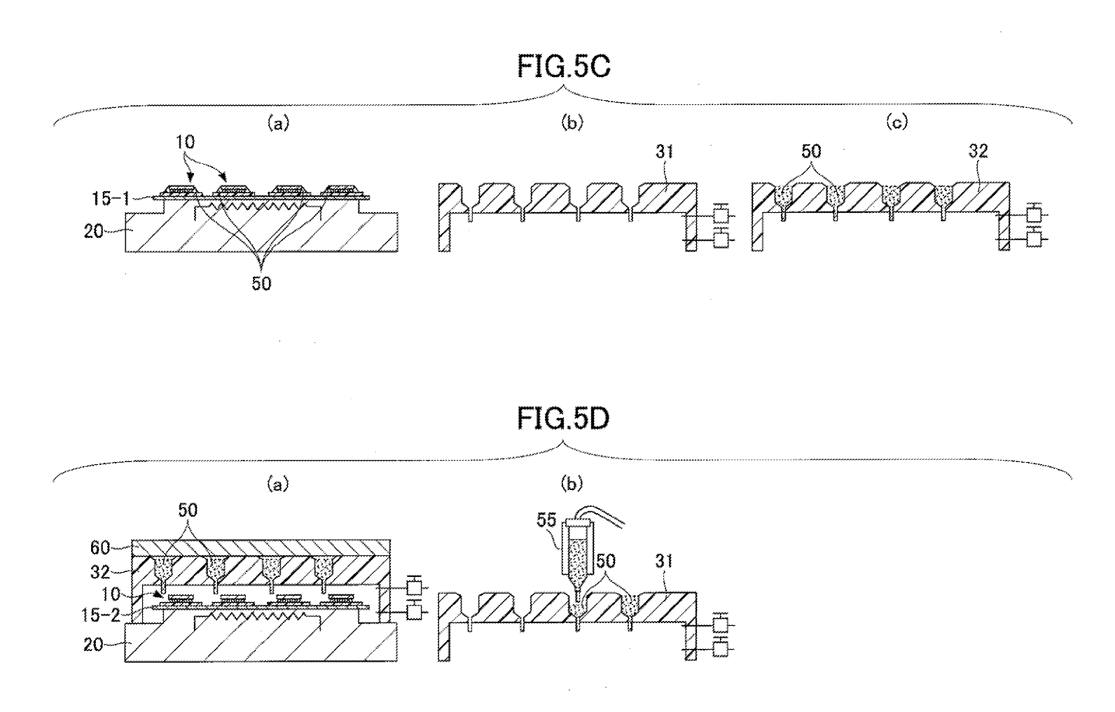

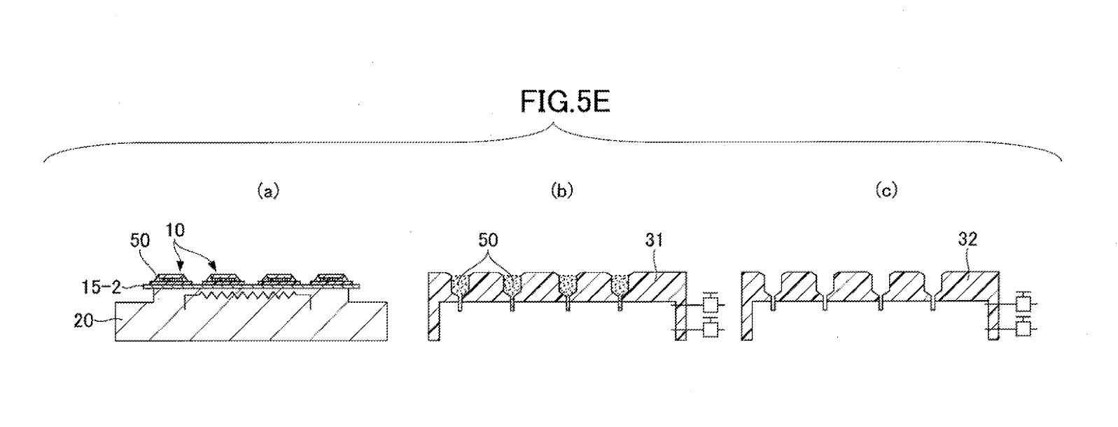

Next, a description is given, with reference to the schematic cross-sectional views of FIGS. 5A through 5E, a dispensing method according to a second embodiment. According to this embodiment, it is possible to apply a liquid material to multiple objects of processing with more efficiency using multiple chambers, for example, cyclically using multiple chambers alternately or one by one in repeatedly applying the liquid material to multiple sets of objects. Here, like in the above-described embodiment, a description is given, taking the case of filling underfill according to side filling.

FIGS. 5A through 5E illustrates, in order in five stages, the placement and the underfill filling of the semiconductor packages 10 on the stage 20 and the feeding of the underfill 50 into the ejection parts (capillaries) 33 of two (first and second) chambers 31 and 32. In FIGS. 5A through 5E, the same elements as those in the case using the single chamber 30 as illustrated in FIGS. 2A through 2E are referred to by the same reference numerals, and a description thereof is omitted. Further, in FIGS. 5A through 5E, (a) illustrates the semiconductor packages 10 on the stage 20, (b) illustrates the first chamber 31, and (c) illustrates the second chamber 32.

As illustrated in FIG. 5A, the semiconductor packages 10 are placed (provided) on the stage 20. Prior to or in parallel with this, a predetermined amount of the underfill liquid material 50 is fed into each of the capillaries 33 using the dispenser 55. In this case, each of the first and second chambers 31 and 32 has the four capillaries 33, and the four semiconductor packages 10 are arranged on a first carrier 15-1 and disposed on the stage 20.

Next, as illustrated in FIG. 5B, the first chamber 31 and the lid member 60 are provided on the stage 20 and the simultaneous application of the liquid material 50 to the four semiconductor packages 10 on the stage 20 is started. Further, the feeding of the liquid material 50 into the capillaries 33 of the second chamber 32 is started. This feeding of the liquid material 50 to the second chamber 32 may be performed using the same dispenser 55 as used for feeding the liquid material 50 to the first chamber 31.

As the reduction of the pressure inside the first chamber 33 progresses, the liquid material 50 inside the capillaries 33 of the first chamber 31 is pushed out, so that (the air gaps of) the semiconductor packages 10 are filled with the underfill 50. Thereafter, the first chamber 31 is vented to the atmosphere. As a result, even if a void is generated in the underfill 50, the void is reduced or substantially eliminated. During this stage in the process, the feeding of the underfill (liquid material) 50 into the capillaries 33 of the second chamber 32 may be completed.

Next, as illustrated in FIG. 5C, the lid member 60 and the first chamber 31 are removed from the stage 20. Then, the four semiconductor packages 10 subjected to the underfilling are taken out together with the first carrier 15-1.

Next, as illustrated in FIG. 5D, a second carrier 15-2 carrying the other semiconductor packages 10, the second chamber 32, and the lid member 60 are placed on the stage 20, and the filling of the underfill 50 is started. Further, the feeding of the liquid material 50 into the capillaries 33 of the first chamber 31 is started. Then, in the same manner as described with reference to FIG. 5B, the filling of the underfill 50 to the semiconductor packages 10 on the second carrier 15-2 and the feeding of the liquid material 50 into the capillaries 33 of the first chamber 31 are completed.

Next, as illustrated in FIG. 5E, the lid member 60 and the second chamber 32 are removed from the stage 20. Then, the four semiconductor packages 10 subjected to the underfilling are taken out together with the first carrier 15-2.

It is possible to fill more semiconductor packages 10 with the underfill 50 by thereafter advancing the process by repeating the stages of FIGS. 5B through 5E, interchanging the two chambers 31 and 32 with each other. Typically, the carriers (15-1 and 15-2) are used directly in a subsequent underfill hardening process. Therefore, third, fourth . . . carriers that carry more semiconductor packages 10 may be used.

According to the case illustrated in FIGS. 5A through 5E, the two chambers 31 and 32 are provided so that while one of the chambers 31 and 32 applies the liquid material 50 to the semiconductor packages 10, the other one of the chambers 31 and 32 may be fed in advance with the liquid material 50. Therefore, it is possible to start reducing the pressure inside the chamber 31 or 32 immediately after placing the chamber 31 or 32 (and the lid member 60) on the stage 20. Accordingly, it is possible to reduce the process time of the dispensing process more effectively in the case of manufacturing a large number of semiconductor packages in particular.

In the case illustrated in FIGS. 5A through 5E, the two chambers 31 and 32 and the single dispenser 55 are used. However, it is also possible to use three or more chambers and/or two or more dispensers. For example, in the case of performing dispensing on multiple semiconductor packages arranged in a matrix at the same time, the feeding of a liquid material to capillaries with a dispenser could be a temporal bottleneck. In such a case, for example, two or more dispensers may be used to feed the liquid material in advance to the capillaries of one or more chambers that are not in the process of dispensing the liquid material to semiconductor packages.

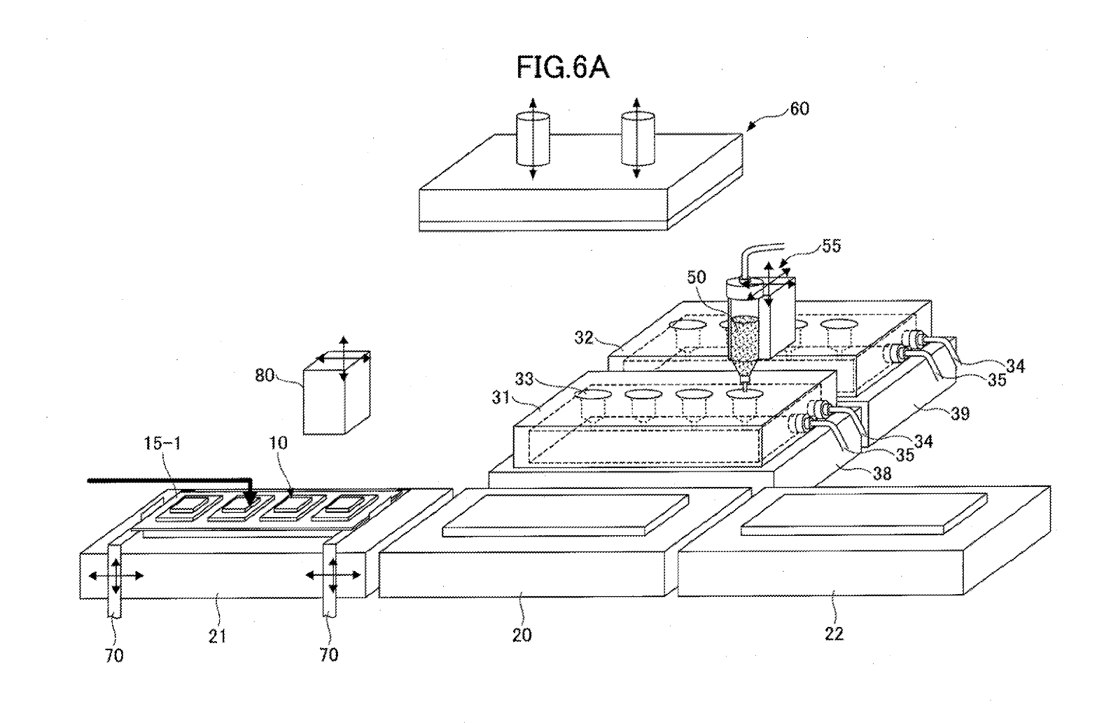

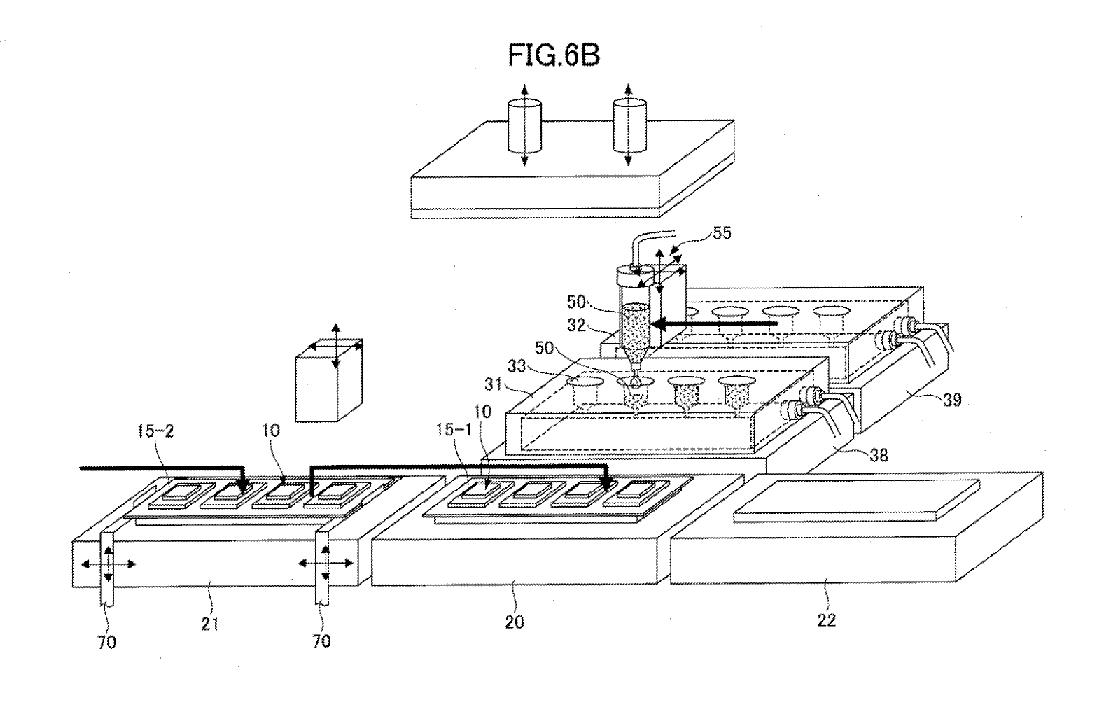

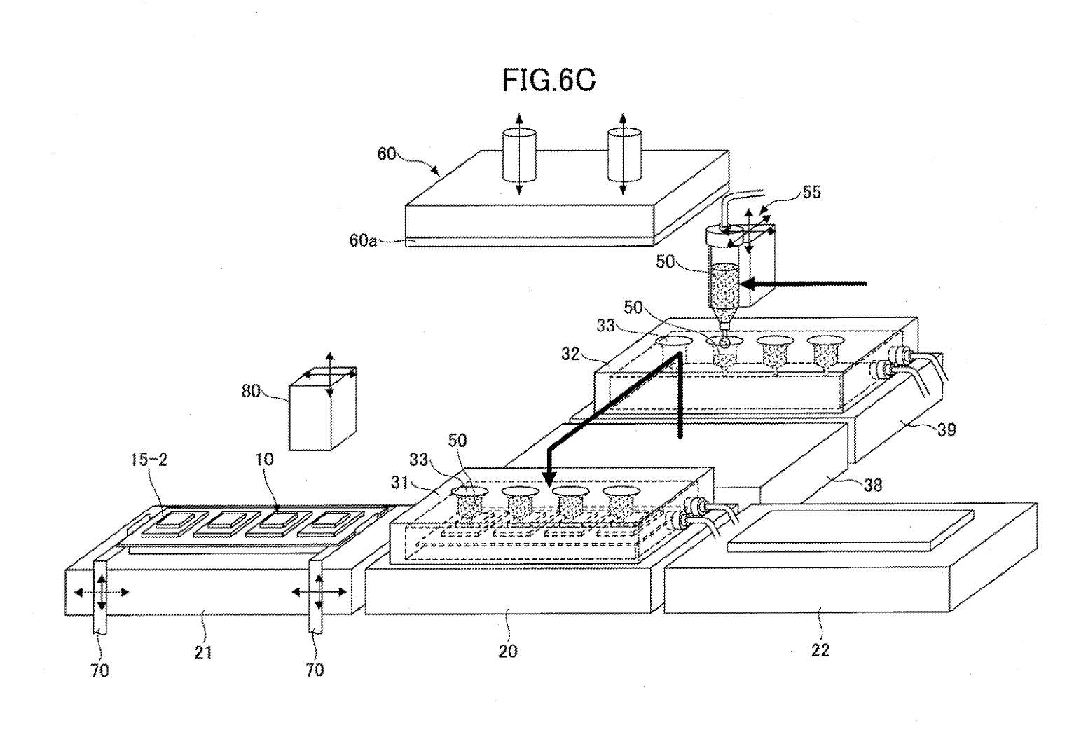

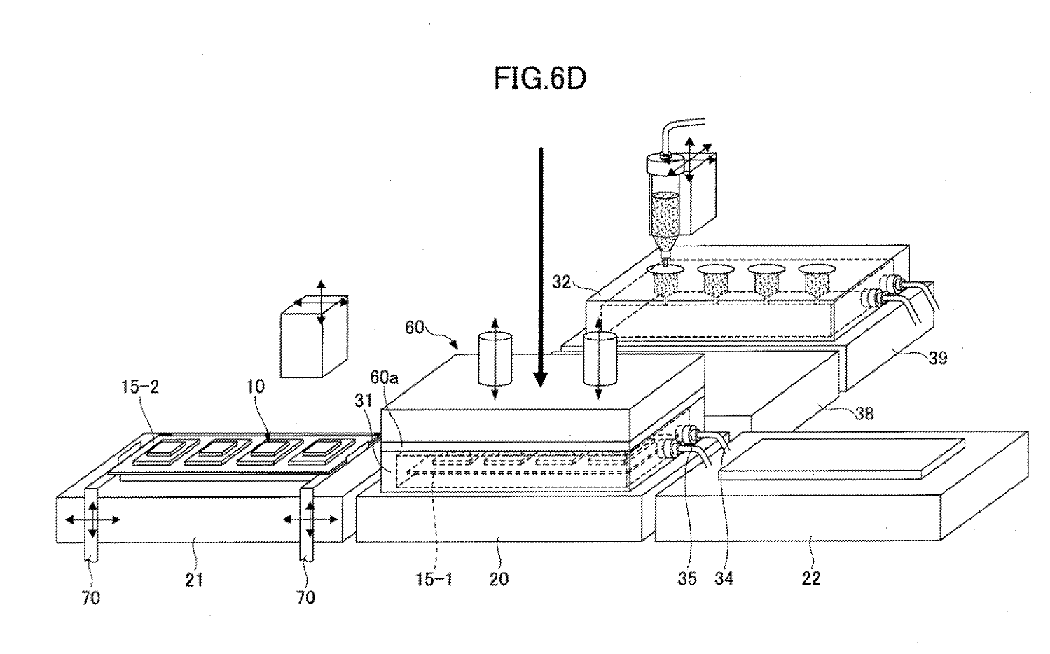

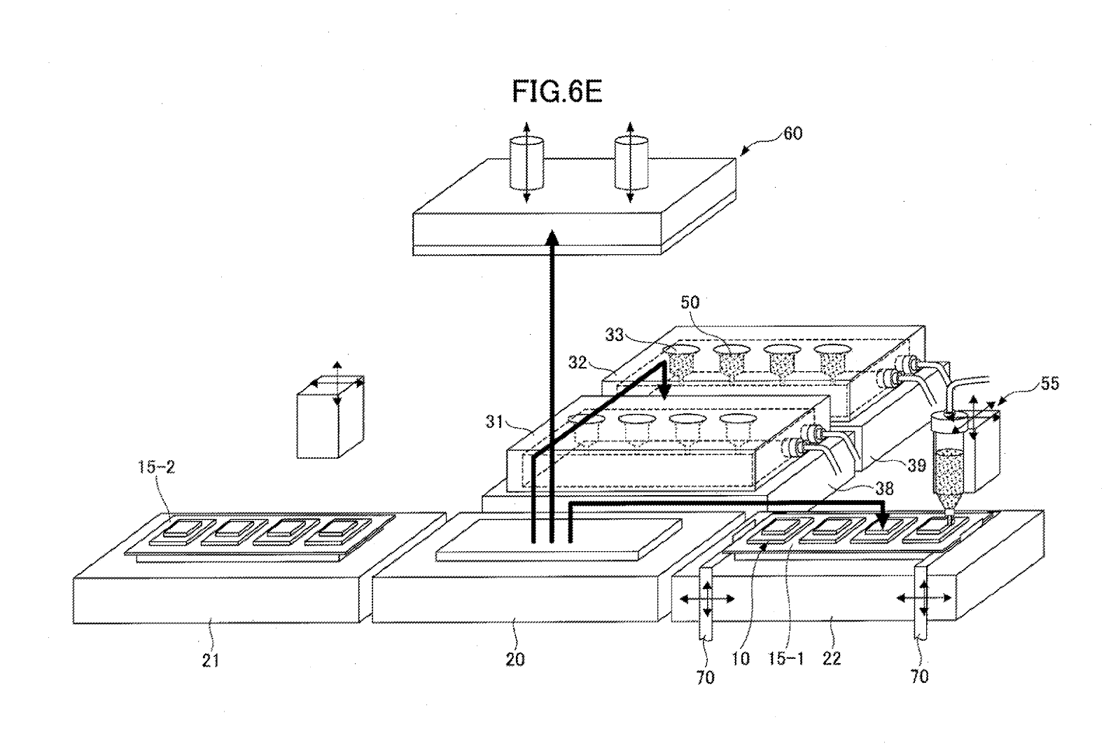

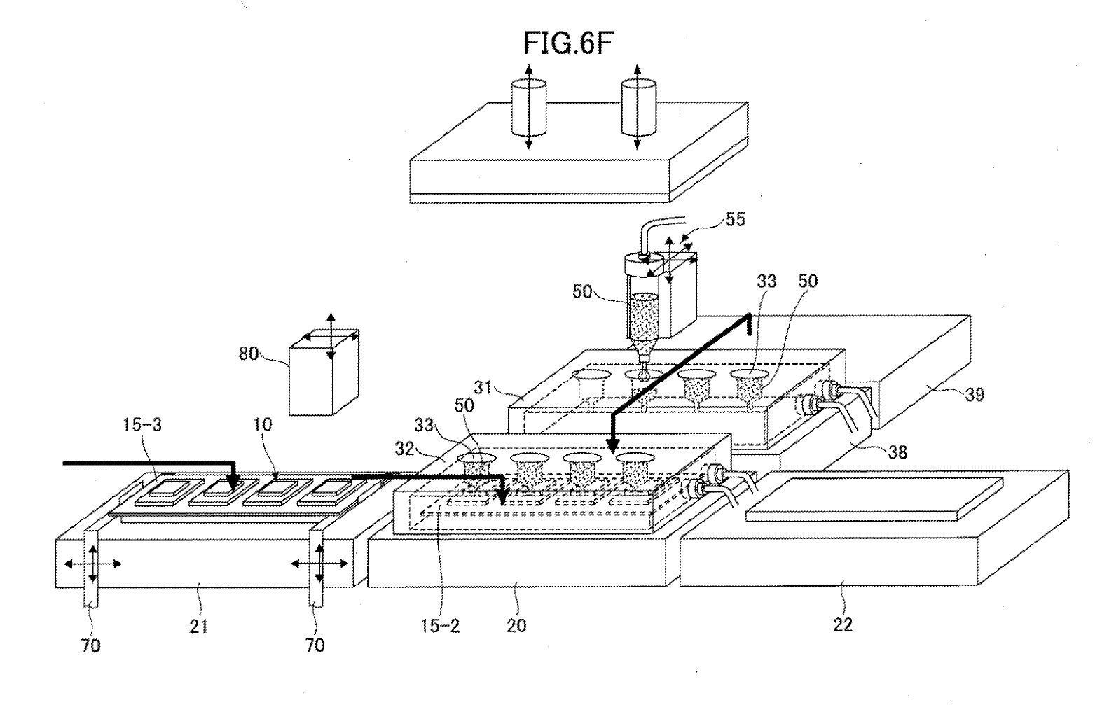

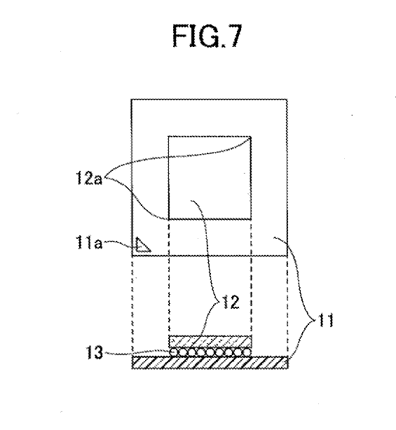

Next, a description is given in more detail of the dispensing method illustrated in FIGS. 5A through 5E, referring to a more detailed case illustrated in the perspective views of FIGS. 6A through 6F. In this case, an underfill applying apparatus is used that includes three stages (the main stage 20, a pre-stage 21, and a post-stage 22), the two chambers 31 and 32, two (first and second) chamber bases 38 and 39, the single lid member 60, and the single dispenser 55. Each of the chambers 31 and 32 includes the inlet port 34 and the outlet port 35 for the reduction of its internal (inside) pressure and its ventilation to the atmosphere.

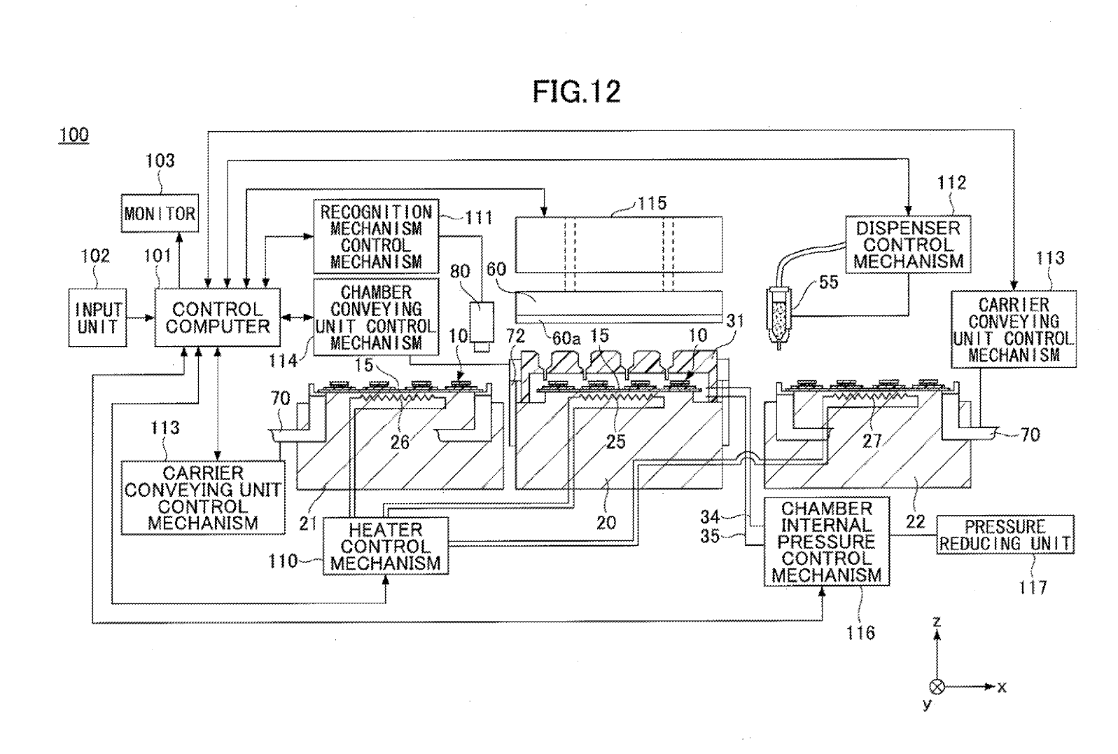

As illustrated in FIG. 6A, the first carrier 15-1 carrying the one or more semiconductor packages 10 is conveyed onto the pre-stage 21 with a conveying unit (hereinafter referred to as a “carrier conveying unit”) 70. In the following description, it is assumed that the carriers 15 (15-1, 15-2, etc.) that carry the four semiconductor packages 10 each are used. The pre-stage 21 preferably has a built-in temperature-controllable heater 26 (FIG. 12) to be able to heat the semiconductor packages 10 on the pre-stage 21 to a predetermined temperature. For example, this predetermined temperature may be equal to the heater temperature of the below-described main stage 20 as preheat for underfill filling in a heated condition.

Preferably, a recognition mechanism 80, for example, an image capturing device such as a camera or a detecting device such as a sensor, is provided near the pre-stage 21. The recognition mechanism 80 is configured to detect the presence or absence of the carrier 15-1 and/or the semiconductor packages 10 on the pre-stage 21. For example, the shape of an identification mark 11a on the wiring board 11 and the coordinates of corners 12a (for example, two diagonally opposite corners) may be subjected to image capturing and recognized (determined) using a camera as the recognition mechanism 80. This makes it possible to detect the number of semiconductor packages 10 on the carrier 15-1, the presence or absence of the mixing of a wrong package, and/or the position information of the semiconductor chips 12.

Next, as illustrated in FIG. 6B, the carrier 15-1 is conveyed onto the main stage 20 with the carrier conveying unit 70, and if there are (subsequent) semiconductor packages 10 to be processed that follow, the second carrier 15-2 carrying the subsequent semiconductor packages 10 is conveyed onto the pre-stage 21 with the carrier conveying unit 70. Further, a predetermined amount of the liquid material 50 is fed to the individual capillaries 33 of the first chamber 31 using the dispenser 55. If the recognition mechanism 80 is provided for the pre-stage 21, it may be determined in accordance with the result of the recognition by the recognition mechanism 80 whether to feed the individual capillaries 33 with the liquid material 50. This feeding of the liquid material 50 may be performed during or before the conveyance of the carrier 15-1 from the pre-stage 21 to the main stage 20 by performing the feeding with the first chamber 31 placed in a location different from the main stage 20 for applying the liquid material 50, for example, on the first chamber base 38 in the graphically illustrated case.

The main stage 20 preferably has the built-in temperature-controllable heater 25 (FIG. 2A and FIG. 12) to be able to heat the semiconductor packages 10 to a temperature suitable for underfill filling through a capillary flow. The first chamber 31 and the second chamber 32 may be formed of one or a combination of various materials such as acrylic resin and stainless steel. An acrylic resin transparent chamber makes it possible to visually monitor the semiconductor packages 10 and/or the liquid material 50 inside the chamber at the time of underfill filling.

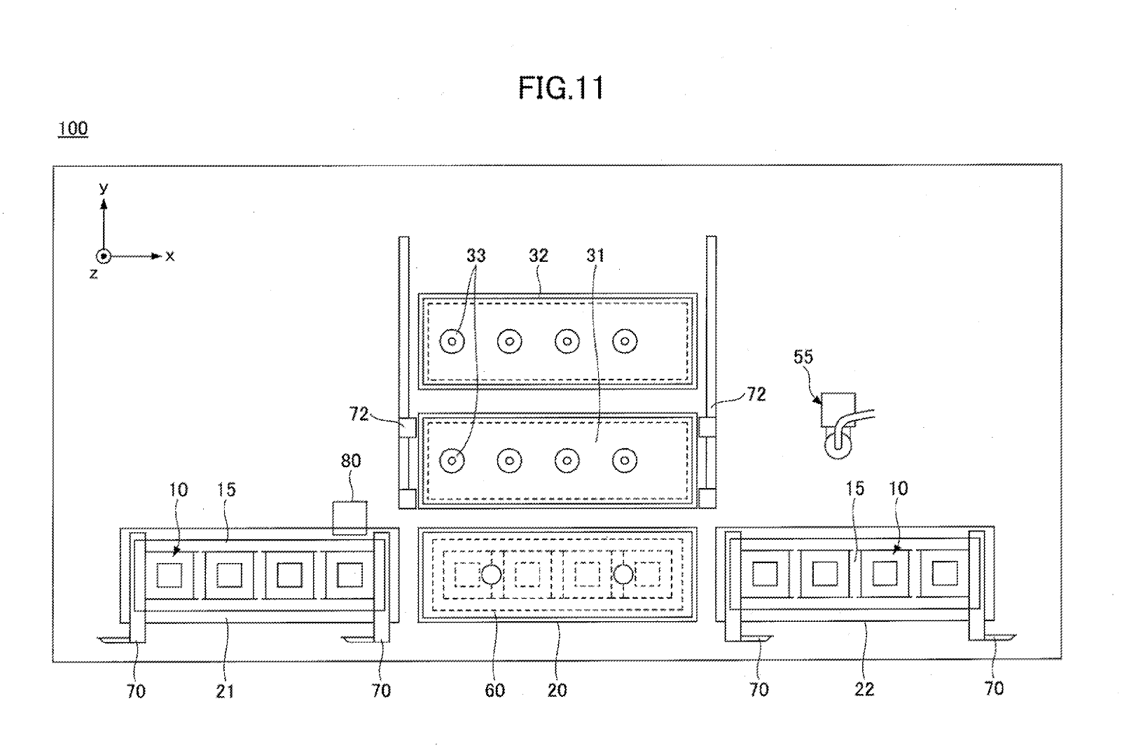

Next, as illustrated in FIG. 6C, the first chamber 31 supplied with the liquid material 50 is placed at a predetermined position on the main stage 20 using a chamber conveying unit 72 (FIG. 11 and FIG. 12). On the chamber 31 (and the chamber 32) or the main stage 20, a packing may be provided where the chamber 31 (and the chamber 32) and the main stage 20 come into contact in order to prevent outside air from entering the chamber 31 (and the chamber 32) at the time of reducing the chamber pressure. If the second carrier 15-2 carrying the subsequent semiconductor packages 10 is present, the feeding may be started of the liquid material 50 to the second chamber 32 on the second chamber base 39 using the dispenser 55. If the recognition mechanism 80 is provided, preferably, it is determined on a capillary basis, based on the result of the recognition by the recognition mechanism 80, whether to feed the capillaries 33 of the second chamber 32 with the liquid material 50.

Next, as illustrated in FIG. 6D, the lid member 60 is lowered to be pressed against the first chamber 31. Then, as described above, the semiconductor packages 10 on the first carrier 15-1 have their air gaps filled with the underfill (liquid material) 50. That is, the pressure inside the chamber 31 is reduced through the outlet port 35 (the liquid material 50 is ejected from the capillaries 33 because of a difference in pressure), the underfill filling is performed through capillary action in the reduced-pressure condition, and the chamber 31 is vented to the atmosphere via the inlet port 34 (a void is reduced/disappears). The lid member 60 may be formed of a rigid body such as metal in order to have sufficient strength. Preferably, the lid member 60 has an elastic material 60a provided at its bottom surface that comes into contact with the chamber 31 (and the chamber 32) in order to prevent outside air from entering a space between the capillaries 33 and the lid member 60 at the time of reducing the chamber pressure.

Next, as illustrated in FIG. 6E, the lid member 60 is lifted to be removed from the first chamber 31, and the first chamber 31 is moved onto the first chamber base 38 by the chamber conveying unit 72 (FIG. 11 and FIG. 12). Further, the first carrier 15-1 is moved onto the post-stage 22 by the carrier conveying unit 70. The post-stage 22 as well may have a built-in temperature-controllable heater 27 (FIG. 12) to heat the semiconductor packages 10 on the post-stage 22 to a predetermined temperature and perform additional underfill application under atmospheric pressure, such as fillet formation, as required. Such additional underfill application on the post-stage 22 may be performed using the dispenser 55 used to feed the capillaries 33 with the underfill (liquid material) 50 or using another dispenser. At this point, the feeding of the underfill 50 to the second chamber 32 has been completed. The first carrier 15-1 carrying the semiconductor packages 10 whose underfill filling has been completed is conveyed (carried out) from the post-stage 22 in preparation for the subsequent underfill hardening process.

Then, as illustrated in FIG. 6F, if the second carrier 15-2 follows, the second carrier 15-2 is conveyed from the pre-stage 21 to the main stage 20, and the second chamber 32 supplied with the underfill (liquid material) 50 is placed on the main stage 20. If the second carrier 15-2 has been preliminarily heated on the pre-stage 21 to a temperature equal to the set temperature of the main stage 20, the pressure reduction of the second chamber 32 may be started immediately after the lid member 60 is pressed against the second chamber 32. Further, if the semiconductor packages 10 to be processed follow, a third carrier 15-3 carrying these semiconductor packages 10 is conveyed onto the pre-stage 21. Further, the first chamber 31 is again supplied with the liquid material 50 using the dispenser 55.

Thereafter, the above-described process is repeated until the end of a process for a carrier carrying the last semiconductor package to be processed. Typically, a group of semiconductor packages whose underfill filling has been completed are loaded together into a heating apparatus such as a thermostat bath to have the underfill hardened by predetermined heat treatment.

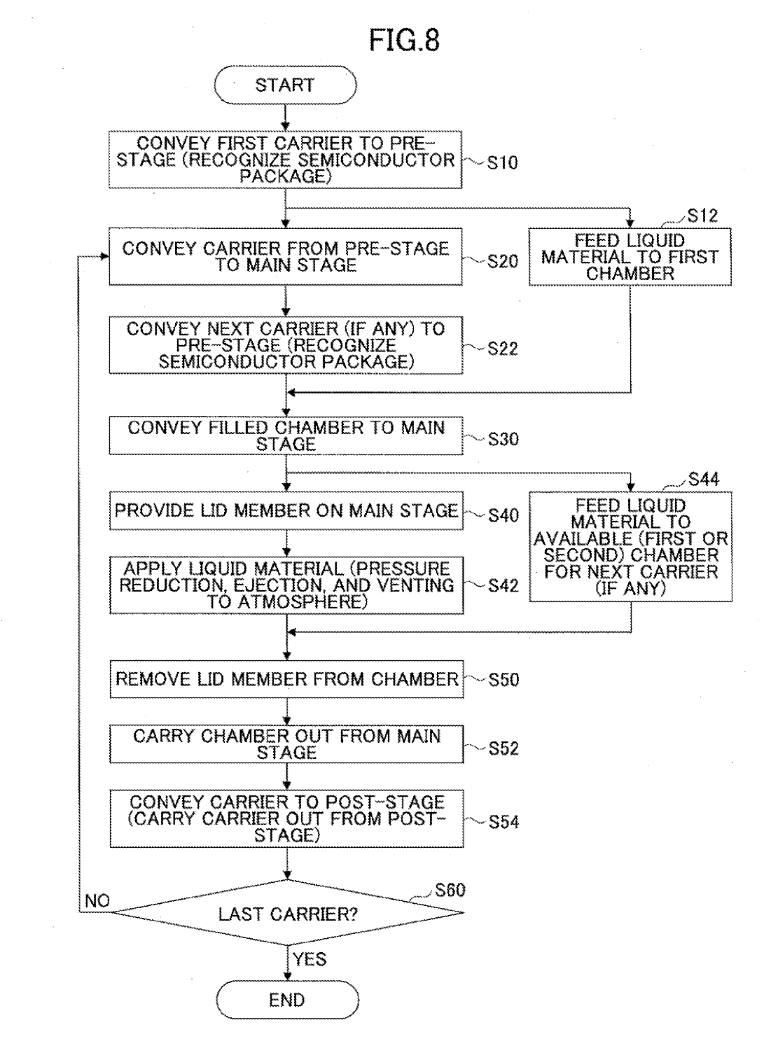

FIG. 8 is a flowchart illustrating the method of dispensing a liquid material described with reference to FIGS. 6A through 6F.

In step S10, as illustrated in FIG. 6A, the first carrier 15-1 is conveyed onto the pre-stage 21. In step S12, the feeding of the liquid material 50 to the first chamber 31 is started.

In step S20, as illustrated in FIG. 6B, the first carrier 15-1 on the pre-stage 21 is conveyed onto the main stage 20. In step S22, as illustrated in FIG. 6B, the next (second) carrier 15-2 is conveyed onto the pre-stage 21.

In step S30, as illustrated in FIG. 6C, the first chamber 31 fed with the liquid material 50 is conveyed onto the main stage 20.

In step S40, as illustrated in FIG. 6D, the lid member 60 is provided on the first chamber 31, and in step S42, as illustrated in FIG. 6D, liquid material application (for example, underfill filling) is performed. Further, in step S44, as illustrated in FIGS. 6D and 6E, the second chamber 32, which is an unused one of the first and second chambers 31 and 32, is fed with the liquid material 50 for the next (second) carrier 15-2.

In step S50, as illustrated in FIG. 6E, the lid member 60 is removed from the first chamber 31. In step S52, as illustrated in FIG. 6E, the first carrier 15-1 is conveyed (carried out) from the main stage 20. In step S54, as illustrated in FIG. 6E, the first carrier 15-1 is conveyed to the post-stage 22. After being subjected to an additional process on the post-stage 22 as required, the first carrier 15-1 is conveyed (carried out) from the post-stage 22 before the next (second) carrier 15-2 is conveyed to the post-stage 22.

Then, in step S60, it is determined whether the process for the last carrier has ended, and if so (YES in step S60), this dispensing method ends. If the next (second) carrier 15-2 is on the pre-stage 21 (NO in step S60), this method returns to step S20, and as illustrated in FIG. 6F, the next (second) carrier 15-2 is conveyed onto the main stage 20. Thereafter, the process of step S20 through step S60 is repeated until the end of a process for the last carrier. At this point, in step S44, the first chamber 31 and the second chamber 32 are alternately selected as an available chamber. The start time and the end time of the feeding of the liquid material 50 to the available chamber in step S44 are not limited to the graphically illustrated examples, and may be subjected to change as long as the feeding of the liquid material 50 is in time for the conveyance of the chamber for use for the next carrier (step S30).

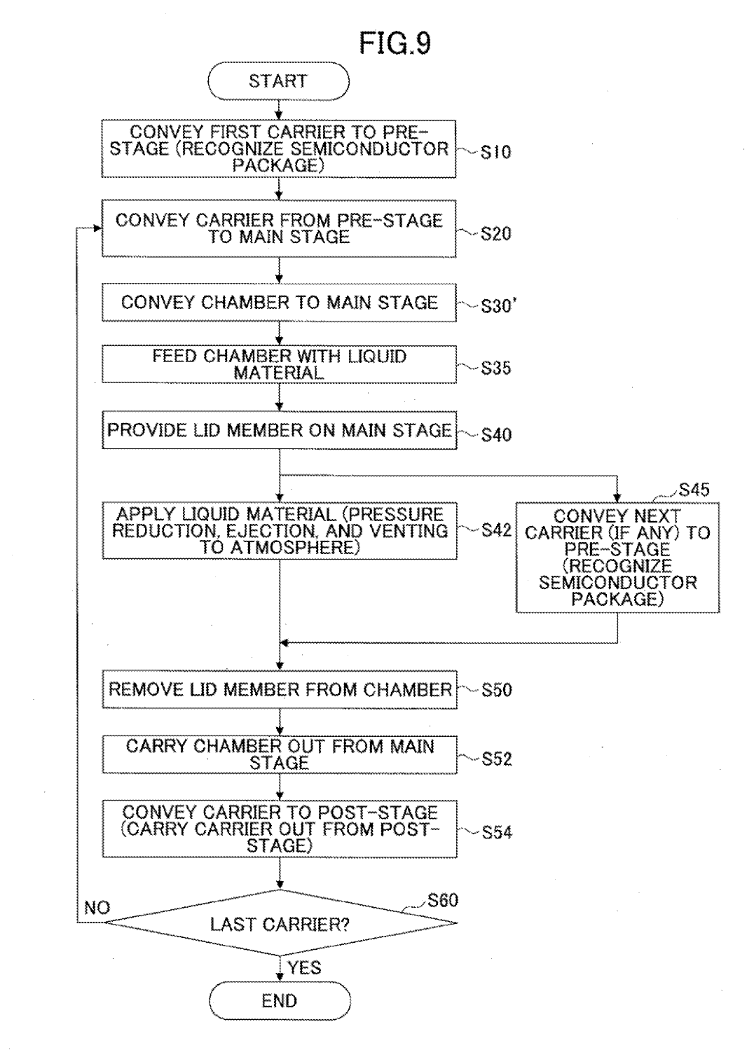

The dispensing method illustrated in FIGS. 6A through 6F, using a dispensing apparatus having the three stages 20, 21, and 22, details the dispensing method using the two chambers 31 and 32 illustrated in FIGS. 5A through 5E. However, the dispensing method using the single chamber 30 as illustrated in FIGS. 2A through 2E (first embodiment) may also be performed using a similar dispensing apparatus having a single chamber and a single chamber base. FIG. 9 illustrates a flowchart in such a case. In FIG. 9, steps that may be the same as those of FIG. 8 are referred to by the same step numbers, and a detailed description thereof is omitted.

The feeding of the liquid material 50 to the single chamber 30 may be performed between the completion of the use of the chamber 30 for a preceding carrier (step S52) and the placement of the lid member 60 on the chamber 30 for a carrier that is a current object of processing (handling) (step S40). For example, as illustrated in FIGS. 2B and 2C, the feeding of the liquid material 50 to the chamber 30 may be performed as step S35 after placement of the chamber 30 on the main stage 20 (step S30′). Further, if there is a subsequent carrier to be handled, the subsequent carrier may be conveyed onto the pre-stage 21 any time after the conveyance of the carrier that is a current object of processing (handling) to the main stage 20 (step S20). However, if heating is performed in the application of the liquid material 50 on the main stage 20 (step S42), it is preferable that the subsequent carrier be preliminarily heated sufficiently on the pre-stage 21. In such a case, it is preferable that the conveyance of the subsequent carrier to the pre-stage 21 be performed, at the latest, in parallel with the start of the application of the liquid material 50 with respect to the carrier that is a current object of processing (handling).

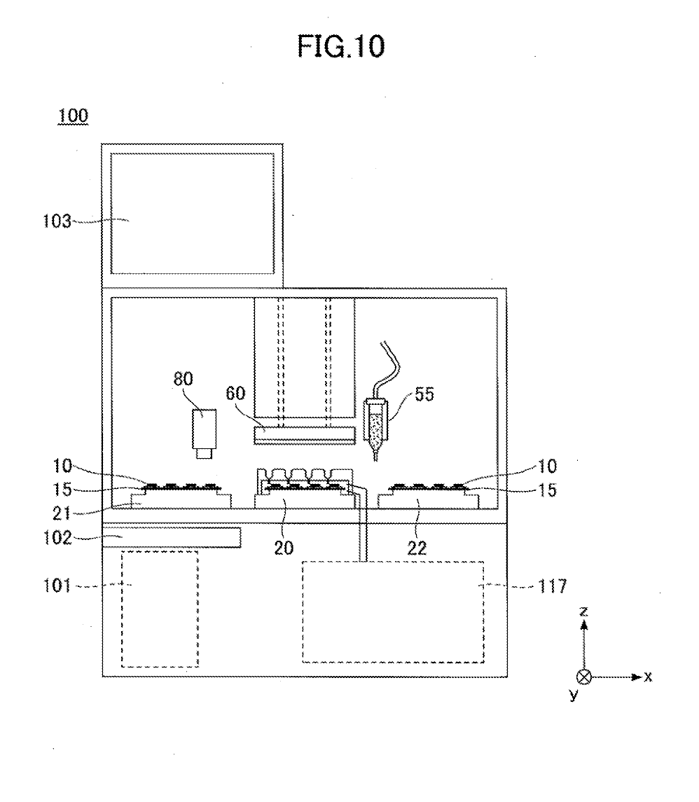

Next, a description is given, with reference to FIG. 10 through FIG. 12, of a liquid material dispensing apparatus 100, which may be used for the dispensing method described in relation to FIGS. 6A through 6F. FIG. 10 is a front view of the dispensing apparatus 100, schematically illustrating the exterior of the dispensing apparatus 100. FIG. 11 is a plan view of part of the dispensing apparatus 100 near its stage part. FIG. 12 is a front view of the dispensing apparatus 100, illustrating the stage part and its vicinity along with the functional blocks of peripheral elements of the stage part.

The dispensing apparatus 100 includes a control computer 101 based on, for example, a workstation or a personal computer. The control computer 101 includes at least one processing unit such as a processor. The control computer 101 also includes an input unit 102 such as a keyboard and/or a mouse and a monitor 103 for interactions with an operator. The control computer 101 may further include a storage unit for storing recipes in which various information items for application of the liquid material 50 are recorded. The recipes may include, for example, the recognition information of the semiconductor packages 10, the position information of the chamber capillaries 33, the temperatures of the heaters 25, 26, and 27 of the main stage 20, the pre-stage 21, and the post-stage 22, respectively, the amount of the liquid material 50 applied, and control information for the pressure reduction and the venting to the atmosphere of the chambers 31 and 32.

The control computer 101 may control the operations of components of the dispensing apparatus 100 in accordance with an input or selected recipe. For example, as illustrated in FIG. 12, the control computer 101 may control the temperatures of the main stage 20, the pre-stage 21, and the post-stage 22 via a heater control mechanism 110, control the recognition mechanism 80 via a recognition mechanism control mechanism 111, and control the dispenser 55 via a dispenser control mechanism 112. The control computer 101 may also control the operations of the carrier conveying unit 70 and the chamber conveying unit 72 via a carrier conveying unit control mechanism 113 and a chamber conveying unit control mechanism 114, respectively. The control computer 101 may further control the position of the lid member 60 via a lid vertical movement mechanism 115.

After a recipe is input or selected, the semiconductor packages 10 carried by the carrier 15 is conveyed to the pre-stage 21 by the carrier conveying unit 70. The recognition mechanism 80, for example, a camera, is moved in the X and Y directions (typically in a horizontal [X-Y] plane) over the pre-stage 21 via the recognition mechanism control mechanism 111, so that the images of the semiconductor packages 10 on the pre-stage 21 are captured. Then, the semiconductor package recognition information (such as the shape of an identification mark and the size and the position of a semiconductor chip) recorded in the recipe are collated with the recognition information obtained by the image capturing.

If it is determined that one or more of the semiconductor packages 10 on the carrier 15 match the semiconductor package recorded in the recipe as a result of the collation, a corresponding one or more of the capillaries 33 of the first chamber 31 are fed with a predetermined amount of the liquid material 50. At this point, typically, the two chambers 31 and 32 may be at withdrawal positions adjacent to the main stage 20 (for example, the chamber bases 38 and 39 in FIGS. 6A through 6F). In order to feed the liquid material 50, the dispenser 55, which is typically configured to move three-dimensionally in the X, Y, and Z directions, is moved via the dispenser control mechanism 112 in accordance with the collation results. If a dummy package is placed on the carrier 15 for reasons such as addressing a fraction or if one or more semiconductor packages 10 are absent from their spots on the carrier 15 (that is, the carrier 15 is not carrying the semiconductor packages 10 to its full capacity), the dispenser 55 is so controlled as to not feed the liquid material 50 to one or more of the capillaries 33 corresponding to the dummy package or the absent semiconductor packages 10.

The carrier 15 on the pre-stage 21 is conveyed to the main stage 20 by the carrier conveying unit 70. If there is a subsequent carrier 15 to be handled, the subsequent carrier 15 may be conveyed to the pre-stage 21. The chamber 31 fed with the liquid material 50 is placed at a predetermined position on the main stage 20 by the chamber conveying unit 72. According to the dispensing apparatus 100 having the multiple chambers 31 and 32, if the subsequent carrier 15 follows, the feeding of the liquid material 50 to the chamber 32, different from the chamber 31 that has been conveyed onto the main stage 20, may be started. The lid member 60 in a withdrawal position over the main stage 20 is lowered by the lid vertical movement mechanism 115 to be pressed against the chamber 31 placed on the main stage 20. As described above, the lid member 60 preferably has the elastic material 60a such as rubber on its surface of contact with the chamber 31 (and the chamber 32). Further, a sealing member such as a packing may be provided at the contact surface of the chamber 31 (and the chamber 32) and the main stage 20.

The outlet port 35 of the chamber 31 on the main stage 20 and a pressure reducing unit 117 such as a vacuum pump are connected via a chamber internal pressure control mechanism 116 including a valve, so that the pressure inside the chamber 31 is reduced. The difference between the pressure of air existing between the liquid material 50 in the capillaries 33 and the lid member 60 and the internal pressure of the chamber 31 causes the liquid material 50 to be pushed out from the capillaries 33 to be applied on the semiconductor packages 10. In the case of underfill filling, the applied liquid material 50 fills in the air gap between the wiring board 11 (FIG. 2A) and the semiconductor chip 12 (FIG. 2A) of each of the semiconductor packages 10 through capillary action. Thereafter, the chamber internal pressure control mechanism 116 disconnects the outlet port 35 of the chamber 31 and the pressure reducing unit 117, and then vents the chamber 31 to the atmosphere via the inlet port 34 of the chamber 31.

The lid member 60 and the chamber 31 on the main stage 20 are moved to their respective withdrawal positions by the lid vertical movement mechanism 115 and the chamber conveying unit 72, respectively. Then, the carrier 15 on the main stage 20 is conveyed to the post-stage 22 by the carrier conveying unit 70. The semiconductor packages 10 conveyed onto the post-stage 22 are subjected to an additional process under atmospheric pressure, such as fillet formation, as required, and are conveyed (carried out) from the post-stage 22 by the carrier conveying unit 70.

If there is a subsequent carrier 15, the subsequent carrier 15 on the pre-stage 21 is conveyed to the main stage 20 in the same manner as the preceding carrier 15, and the other chamber 32 that has been fed with the liquid material 50 is placed on the main stage 20. The dispensing apparatus 100 is allowed to repeat the above-described process until the end of a process for the last carrier 15.

### [c] Third Embodiment

In some cases, it is desired to change or alter the relative positions of an object of processing such as a semiconductor package on a main stage and the nozzle part of a capillary placed above the object of processing. For example, in applying an adhesive agent of relatively high viscosity or in performing underfill filling, it may be desired to cause the nozzle part to perform linear or planar scanning over the object of processing during application of a liquid material. Further, even in the case of positioning the nozzle part at a fixed point over the object of processing during application of a liquid material, the above-described relative positions may be changed after designing a chamber and capillaries in order to optimize the position of application.

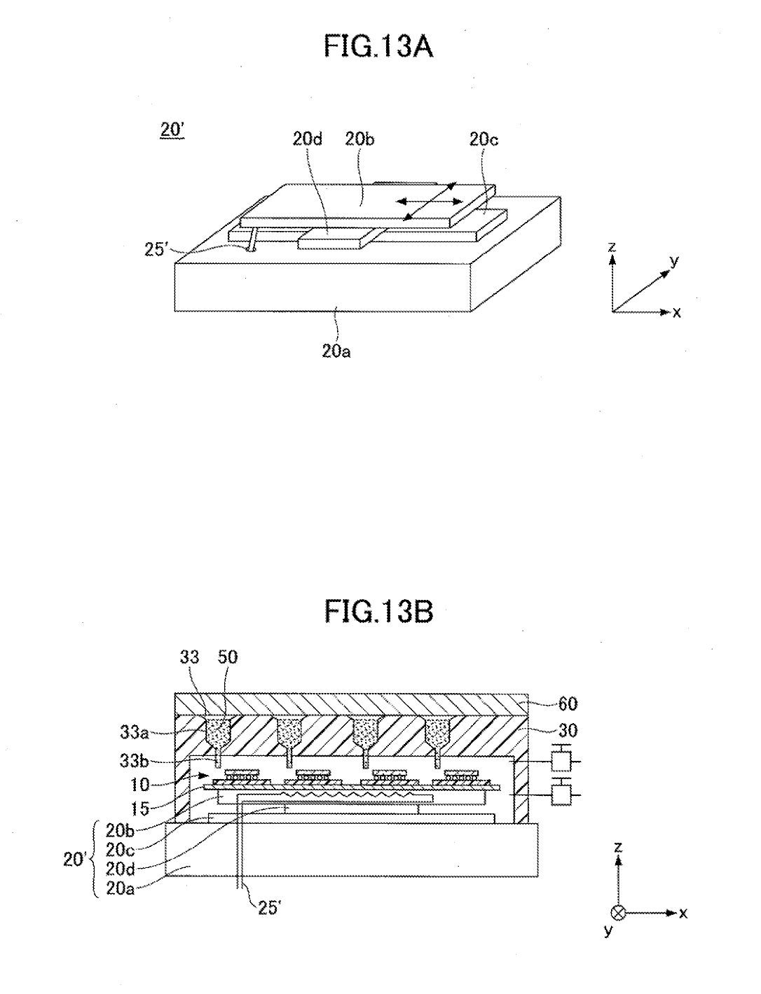

FIGS. 13A and 13B illustrate a main stage 20′ having a mechanism that makes it possible to control the relative positions of an object of processing and the nozzle part of a capillary according to a third embodiment. FIG. 18A is a perspective view of the main stage 20′. FIG. 18B is a cross-sectional view of the main stage 20′ and the chamber 30 and the lid member 60 provided on the main stage 20′.

The main stage 20′ includes a fixed part 20a and a movable part 20b separate from each other. The movable part 20a defines an upper surface of the main stage 20′ on which the carrier 15 carrying objects of processing such as the semiconductor packages 10 is placed. The main stage 20′ further includes an x-direction movement part 20c and a y-direction movement part 20d disposed between the fixed part 20a and the movable part 20b. In the graphically illustrated case, the x-direction movement part 20c is placed on the fixed part 20a to cause the y-direction movement part 20d and the movable part 20b, which are positioned on or above the x-direction movement part 20c, to slide in the x directions. The y-direction movement part 20d is configured to cause the movable part 20b, positioned on the y-direction movement part 20d, to slide in the y directions.

Therefore, when the chamber 30 (or the chamber 31 or 32) having the capillaries 33 is pressed through the lid member 60 against the fixed part 20a, the main stage 20′ is allowed to move the objects of processing (semiconductor packages 10) provided on the movable part 20b (the upper surface of the main stage 20′) in the x and y directions relative to the nozzle parts 33b of the capillaries 33 inside the chamber 30. Accordingly, the main stage 20′ makes it possible to apply the liquid material 50 at an optimum position over the object of processing (semiconductor package 10) or while causing the nozzle part 33b to perform scanning over the object of processing (semiconductor package 10).

A heater 25′ provided in the movable part 20b of the main stage 20′ and the heater control mechanism 110 (FIG. 12) may be connected via a through hole for passing the heater 25′ or its connecting line formed in the fixed part 20a. Further, wiring for actuators that may be included in the x-direction movement part 20c and the y-direction movement part 20d may be provided in the same manner. The through hole is, for example, filled with resin after wiring, so that formation of a hermetic space between the main stage 20′ and the chamber 30 may be ensured.

According to an aspect of the invention, because of reduction of the pressure inside a chamber, a liquid material is dispensed from an ejection part of the chamber, fed in advance with the liquid material, onto an object of processing. The feeding of the liquid material to the ejection part is not performed under reduced pressure. Therefore, it is possible to dispense the liquid material under reduced pressure without exposing a dispenser to a reduced-pressure atmosphere, so that it is possible to prevent generation of voids.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

What is claimed is:

1. A dispensing method, comprising:
feeding a liquid material to one or more ejection parts arranged in a chamber;
placing one or more objects on a stage;
placing the chamber on the stage and forming a first hermetic space between the chamber and the stage;
placing a lid member on the chamber and forming a second hermetic space between the liquid material and the lid member;
causing the liquid material to be ejected from the one or more ejection parts onto the one or more objects by reducing a pressure of the first hermetic space; and
returning the first hermetic space to atmospheric pressure.

2. The dispensing method as claimed in claim 1, wherein:
the one or more objects are one or more semiconductor packages,
the liquid material is underfill, and
said causing the liquid material to be ejected includes filling the one or more semiconductor packages with the underfill.

3. The dispensing method as claimed in claim 1, wherein said causing the liquid material to be ejected includes causing the liquid material to be ejected simultaneously from the multiple ejection parts onto the multiple objects.

4. The dispensing method as claimed in claim 3, further comprising:
recognizing a number and positions of the multiple objects on a single carrier, the multiple objects being carried on the single carrier and conveyed,
wherein said feeding the liquid material includes feeding the liquid material to one or more of the multiple ejection parts corresponding to the recognized number and positions of the multiple objects.

5. The dispensing method as claimed in claim 1, wherein said causing the liquid material to be ejected includes reducing the pressure of the first hermetic space to a pressure between 1 kPa to 10 kPa.

6. The dispensing method as claimed in claim 1, further comprising:
removing the lid, the chamber, and the one or more objects from the stage and placing one or more additional objects on the stage after said returning the first hermetic space to the atmospheric pressure; and
feeding the liquid material to one or more ejection parts arranged in an additional chamber different from said chamber,
wherein said feeding the liquid material to the one or more ejection parts arranged in the additional chamber is completed before completion of said removing the lid, the chamber, and the one or more objects from the stage.

7. The dispensing method as claimed in claim 6, wherein:
said causing the liquid material to be ejected includes heating the one or more objects, and
said feeding the liquid material to the one or more ejection parts arranged in the additional chamber is performed during preliminary heating of the one or more additional objects.

8. A dispensing method, comprising:
applying a liquid material to a plurality of sets of objects, each of the plural sets of objects including one or more of the objects,
said applying with respect to each of the plural sets of objects including
feeding the liquid material to one or more ejection parts of a chamber;
placing the set of objects on a stage;
placing the chamber on the stage and forming a first hermetic space between the chamber and the stage;
placing a lid on the chamber and forming a second hermetic space between the liquid material and the lid;
causing the liquid material to be ejected from the one or more ejection parts onto the set of objects by reducing a pressure of the first hermetic space; and
returning the first hermetic space to atmospheric pressure and removing the lid, the chamber, and the set of objects from the stage,
wherein plural chambers including said chamber are cyclically used one by one in repeating said applying the liquid material to the plural sets of objects.

9. The dispensing method as claimed in claim 8, wherein in said applying a liquid material to a first one and a following second one of the plural sets of objects, said feeding the liquid material for the second one of the plural sets of objects is completed before completion of said applying the liquid material to the first one of the plural sets of objects.

10. A dispensing apparatus, comprising:
a stage configured to have one or more objects placed thereon;
a chamber configured to be placed on the stage, the chamber including one or more ejection parts;
a dispenser configured to feed a liquid material to the one or more ejection parts;
a lid configured to be placed on the chamber; and
a pressure control mechanism,
wherein
a first hermetic space is formed between the stage and the chamber and a second hermetic space is formed between the liquid material and the lid in response to the chamber fed with the liquid material being placed on the stage and the lid being placed on the chamber, and
the pressure control mechanism is configured to reduce a pressure of the first hermetic space so that the liquid material is ejected from the one or more ejection parts onto the one or more objects inside the first hermetic space and thereafter return the first hermetic space to atmospheric pressure by venting the first hermetic space to an atmosphere.

11. The dispensing apparatus as claimed in claim 10, wherein each of the one or more ejection parts comprises:
a syringe part configured to store the liquid material; and
a nozzle part configured to eject the liquid material, the nozzle part projecting into the first hermetic space.

12. The dispensing apparatus as claimed in claim 11, wherein the stage comprises a movable part configured to move the one or more objects placed on the stage relative to the nozzle parts.

13. The dispensing apparatus as claimed in claim 10, wherein the multiple ejection parts are configured to simultaneously eject the liquid material onto the multiple objects placed on the stage in response to said reducing the pressure of the first hermetic space.

14. The dispensing apparatus as claimed in claim 13, further comprising:
an additional stage configured to have the multiple objects placed thereon prior to placement of the multiple objects on the stage; and
a recognition mechanism configured to recognize a number and positions of the multiple objects placed on the additional stage,
wherein the dispenser is configured to be so controlled as to feed the liquid material to one or more of the multiple ejection parts corresponding to the number and positions of the multiple objects recognized by the recognition mechanism.

15. The dispensing apparatus as claimed in claim 10, comprising:
a plurality of chambers including said chamber so that the plural chambers are cyclically used.
